(19) United States
(12) Patent Application Publication
(10) Pub. No.: US 2014/0185458 A1
(43) Pub. Date: Jul. 3, 2014

(54) METHOD FOR MANAGING ERROR IN MULTICAST OR BROADCAST TRANSMISSION AND APPARATUS THEREOF

(71) Applicant: Electronics and Telecommunications Research Institute, (US)

(72) Inventors: Sung Jin YOO, Daejeon (KR); Jin Suk PAK, Daejeon (KR); Byung Jang JEONG, Daejeon (KR)

(73) Assignee: Electronics and Telecommunications Research Institute, Daejeon (KR)

(21) Appl. No.: 13/867,600

(22) Filed: Apr. 22, 2013

(30) Foreign Application Priority Data
Dec. 27, 2012 (KR) 10-2012-0154565

(51) Int. Cl. H04W 24/08

(52) U.S. Cl. CPC H04W 24/08
USPC 370/242

(57) ABSTRACT

Disclosed are a method of managing an error in wireless transmission, and an apparatus thereof, and more particularly, a method of managing an error in multicast or broadcast transmission, and an apparatus thereof. The method of managing an error in multicast or broadcast transmission disclosed in the present invention includes: receiving data multicasted or broadcasted to a plurality of receivers; determining whether the data is normally received; selecting a random resource among wireless resources through which an acknowledgement indicating whether the data is normally received is to be transmitted; and transmitting the acknowledgement indicating whether the data is normally received through the selected random resource.

### CROSS-REFERENCE TO RELATED APPLICATIONS

This application claims priority to and the benefit of Korean Patent Application No. 10-2012-0154565 filed in the Korean Intellectual Property Office on Dec. 27, 2012, the entire contents of which are incorporated herein by reference.

### TECHNICAL FIELD

The present invention relates to a method of managing an error in wireless transmission and an apparatus thereof, and more particularly, a method of managing an error in multicast or broadcast transmission and an apparatus thereof.

### BACKGROUND ART

In wireless communication, a data transmission mode may be generally classified into a unicast mode, a multicast mode, and a broadcast mode. In general, in order to transmit data by the unicast mode, a wireless channel is demanded for each device, and the wireless channel may be divided based on a time, a frequency, or a code to transmit data. The unicast mode may be usefully used when different data is transmitted for each receiver. When an error is generated during transmission by the unicast transmission mode, a transmitter may retransmit data in which an error is generated through an acknowledgement (ACK) or a negative acknowledgement (NACK) via a feedback channel given to each device.

Since identical information is transmitted to a corresponding user in the general multicast or broadcast communication, data is transmitted through a common channel to all receivers, differently from the unicast mode. The multicast or broadcast mode has an advantage of transmitting data to many receivers with the relatively small amount of wireless resources. However, the multicast or broadcast transmission mode does not provide a separate feedback channel to each receiver, so that when an error is generated in received data, it is difficult to correct the error.

In order to supplement an error problem in the multicast or broadcast transmission, assignment of a unique feedback channel to each receiver may be considered, but such a method may negate the effect of being useful use of wireless resources by the multicast or broadcast transmission.

### SUMMARY OF THE INVENTION

The present invention has been made in an effort to provide a method of managing an error in multicast or broadcast transmission capable of effectively managing an error without requiring large overhead, and an apparatus thereof.

An exemplary embodiment of the present invention provides a method of managing an error in multicast or broadcast transmission, including: receiving data multicasted or broadcasted to a plurality of receivers; determining whether the data is normally received; selecting a random resource among wireless resources through which an acknowledgement indicating whether the data is normally received is to be transmitted; transmitting the acknowledgement indicating whether the data is normally received through the selected random resource.

Another exemplary embodiment of the present invention provides a receiver in multicast or broadcast transmission, including: a reception unit configured to receive data multicasted or broadcasted to a plurality of receivers; a determination unit configured to determine whether the data is normally received; a selection unit configured to select a random resource among wireless resources through which an acknowledgement indicating whether the data is normally received is to be transmitted; and a transmission unit configured to transmit the acknowledgement indicating whether the data is normally received through the selected random resource.

Yet another exemplary embodiment of the present invention provides a method of managing an error in multicast or broadcast transmission, including: transmitting multicasted or broadcasted data to a plurality of receivers; receiving an acknowledgement indicating whether the data is normally received through a random resource selected from wireless resources, through which the acknowledgement indicating whether the data is normally received is to be transmitted, from the plurality of receivers; and determining whether to retransmit the data based on a comparison result obtained by comparing the number of received acknowledgements indicating whether the data is normally received and a predetermined acknowledgement threshold value.

Still another exemplary embodiment of the present invention provides a transmitter in multicast or broadcast transmission, including: a transmission unit configured to transmit multicasted or broadcasted data to a plurality of receivers; a reception unit configured to receive an acknowledgement indicating whether the data is normally received through a random resource selected from wireless resources, through which the acknowledgement indicating whether the data is normally received is to be transmitted, from the plurality of receivers; and a determination unit configured to determine whether to retransmit the data based on a comparison result obtained by comparing the number of received acknowledgements indicating whether the data is normally received and a predetermined acknowledgement threshold value.

According to exemplary embodiments of the present invention, it is possible to effectively manage an error without requiring large overhead.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram for describing an entire system in multicast or broadcast transmission disclosed in the present invention.

FIG. 2 is a flowchart for describing an error management method in multicast or broadcast transmission by a receiver 121 of FIG. 1 disclosed in the present invention.

FIG. 3 is a diagram for describing the receiver 121 in multicast or broadcast transmission illustrated in FIG. 1 disclosed in the present invention.

FIG. 4 is a flowchart for describing an error management method in multicast or broadcast transmission by a transmitter 110 of FIG. 1 disclosed in the present invention.

FIG. 5 is a diagram for describing the transmitter 110 in multicast or broadcast transmission illustrated in FIG. 1 disclosed in the present invention.

FIG. 6 is a diagram for comparing and describing the error management method in multicast or broadcast transmission disclosed in the present invention and that of the related art.

FIG. 7 is a diagram for describing an exemplary embodiment in which the error management method in multicast or broadcast transmission disclosed in the present invention is applied to an orthogonal frequency-division multiple access (OFDMA) transmission mode.

FIG. 8 is a diagram for describing an exemplary embodiment in which a NACK is used as an acknowledgement indicating whether data is normally received in the error management method in multicast or broadcast transmission disclosed in the present invention.

FIG. 9 is a diagram for describing an exemplary embodiment of signals for an acknowledgement indicating whether data is normally received in the receiver 121 in the error management method in multicast or broadcast transmission disclosed in the present invention.

FIG. 10 is a diagram for describing an exemplary embodiment in which weight information is included in a signal for an acknowledgement indicating whether data is normally received in the error management method in multicast or broadcast transmission disclosed in the present invention.

FIG. 11 is a diagram for describing an exemplary embodiment of an operation of the transmitter 110 in multicast or broadcast transmission disclosed in the present invention.

FIG. 12 is a diagram for describing an exemplary embodiment of an operation of the receiver 121 in multicast or broadcast transmission disclosed in the present invention.

FIG. 13 is a diagram for describing an exemplary embodiment of an acknowledgement which a data transmitter receives through random feedback when OFDMA is used in multicast or broadcast transmission disclosed in the present invention.

FIG. 14 is a diagram for schematically describing a concept of the error management method in multicast or broadcast transmission disclosed in the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings.

Contents below are simple examples of a principle of the invention. Accordingly, a person skilled in the art may implement the principle of the invention and invent various apparatuses included in a concept and a scope of the invention although it is not clearly described or illustrated in the present invention. Further, all conditional terms and exemplary embodiments enumerated in the present invention have a clear intention only for the purpose of understanding the concept of the invention in principle, and shall not be understood that the conditional terms and exemplary embodiments are limited to the specially enumerated exemplary embodiments and states.

It shall be understood that all detailed descriptions enumerating a specific exemplary embodiment, as well as the principle, the aspect, and the exemplary embodiments of the present invention are intended to include a structural and functional equivalent thereof. Further, it shall be understood that the equivalents include an equivalent to be developed in the future, that is, every element invented so as to perform the same function regardless of a structure, as well as a currently publicly-known equivalent.

Accordingly, for example, a block diagram in the present invention should be understood to indicate an exemplary conceptual point of view for embodying a principle of the present invention. Similarly, all of the flowcharts, state conversion diagrams, and pseudo codes, should be understood to be substantially expressed in computer-readable media and to express a variety of processes performed by a computer or a processor, regardless of whether the computer or the processor is clearly illustrated.

Functions of various devices illustrated in the drawings including functional blocks that are expressed as a processor or a concept similar thereto may be provided for use of dedicated hardware and use of hardware having the capability to execute software in association with appropriate software. When the functions are provided by the processor, the functions may be provided by a single dedicated processor, a single shared processor, or a plurality of individual processors, and a portion thereof may be shared.

Further, clear use of the processor, control, or terminology proposed as a similar concept thereto should not be interpreted by exclusively citing hardware having the capability to execute software, and should be understood to allusively include digital signal processor (DSP) hardware, ROM for storing software, RAM, and a non-volatile memory without restriction. Publicly known and commonly used other hardware may be included.

In the claims of the present invention, constituent elements expressed as means for performing functions described in the detailed description have an intent of including, for example, all methods performing a function including a combination of circuit elements performing the function or all types of software including a firmware/microcode, and are combined with a circuit appropriate for executing the software so as to perform the function. Since the invention defined in the claims is combined with functions provided by various numerated means and combined with a scheme demanded by the claim, any means capable of providing the function should be understood to be an equivalent to that recognized from the present invention.

The aforementioned objects, characteristics, and advantages will be more apparent through the detailed description below related to the accompanying drawings, and thus those skilled in the art to which the present invention pertains will easily implement the technical spirit of the present invention. In the following description, a detailed explanation of known related functions and constitutions may be omitted so as to avoid unnecessarily obscuring the subject matter of the present invention. Hereinafter, an exemplary embodiment according to the present invention will be described in detail with reference to the accompanying drawings.

Exemplary embodiments disclosed in the present invention may be applied to various communication systems. A wireless communication network may be applied to various wireless communication systems by using various air interfaces and/or physical layers (for example, frequency division multiple access, (FDMA), time division multiple access (TDMA), code division multiple access (CDMA), wideband CDMA (W-CDMA), and universal mobile telecommunications system (UMTS), long term evolution (LTE) of UMTS, and global system for mobile communications (GSM).

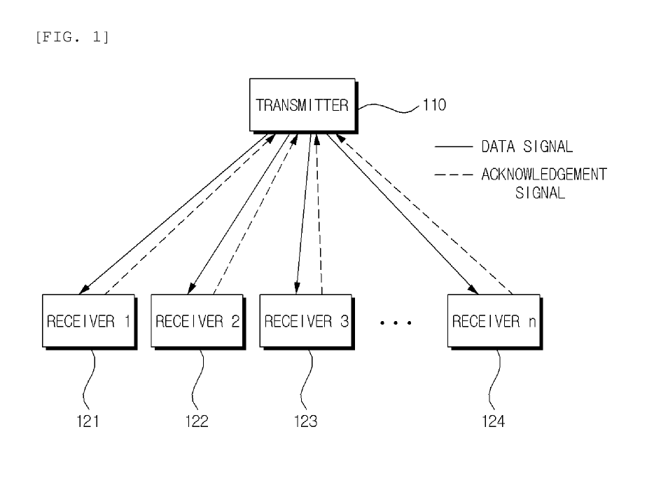

FIG. 1 is a diagram for describing an entire system in multicast or broadcast transmission disclosed in the present invention.

Referring to FIG. 1, a transmitter 110 in multicast or broadcast transmission transmits common data to a plurality of receivers 121, 122, 123, and 124 through a common wireless resource, and the respective receivers 121, 122, 123, and 124 send whether the data is normally received as an acknowledgement. Here, in a broadcast transmission mode, the transmitter 110 transmits data to all of the receivers 121, 122, 123, and 124, but in a multicast transmission mode, the transmitter 110 does not transmit common data to all of the receivers 121, but transmit common data to a plurality of receivers (for example, the receivers 121 and 123). Hereinafter, the present invention will be described based on the broadcast transmission mode, but may be equally applied to the multicast transmission mode.

An acknowledgement indicating whether the data is normally received is transmitted by determining wireless resources through which all of the receivers 121, 122, 123, and 124 may commonly transmit the data, and selecting a resource from the wireless resources, through which the acknowledgement indicating whether the data is normally received in the respective receivers 121, 122, 123, and 124 is to be transmitted, by the respective receivers 121, 122, 123, and 124 according to a predetermined method. Depending on a case, the acknowledgements indicating whether the data is normally received in the plurality of receivers 121, 122, 123, and 124 may overlap one resource block to be transmitted, but even in this case, the transmitter 110 may determine whether to re-transmit the data by calculating probabilistic statistic information of the receivers 121, 122, 123, and 124 for the acknowledgement whether the data is normally received. That is, in order for the transmitter 110 to identify a statistical reception state for the acknowledgement indicating whether the data is normally received (for example, an acknowledgement indicating that retransmission is necessary, when it is determined that the number of resource blocks including the acknowledgement indicating whether the data is normally received is larger than a predetermined threshold, the transmitter 110 may determine retransmission, and when it is determined that the number of resource blocks including the acknowledgement indicating that the retransmission is necessary is smaller than a predetermined threshold, the transmitter 110 may not perform the retransmission. Otherwise, a modulation scheme or a coding scheme of data transmission may be changed by identifying the statistical reception state for the acknowledgement indicating whether the data is normally received in the receivers 121, 122, 123, and 124.

When the number of receivers 121, 122, 123, and 124 is considerably larger than that of resource blocks, whether to transmit the acknowledgement indicating whether the data is normally received in the receivers 121, 122, 123, and 124 may be determined by a specific probability. Accordingly, the receivers 121, 122, 123, and 124 may determine whether to transmit ACK or NACK for the data transmitted by the transmitter 110 according to an acknowledgement transmission probability set by the transmitter 110.

Only a preamble may be transmitted through the acknowledgement indicating whether the data is normally received. Otherwise, the acknowledgement indicating whether the data is normally received may be transmitted by inserting information on whether the data is normally received in the acknowledgement indicating whether the data is normally received together with the preamble. The information on whether the data is normally received may include ACK or NACK information, and may be transmitted by inserting weight information on a degree, by which the receivers 121, 122, 123, and 124 desire to receive the data, in the information on whether the data is normally received. When the acknowledgement information including the weight is transmitted, the transmitter 110 may retransmit the data, or change the modulation or coding scheme for data transmission based on the weight.

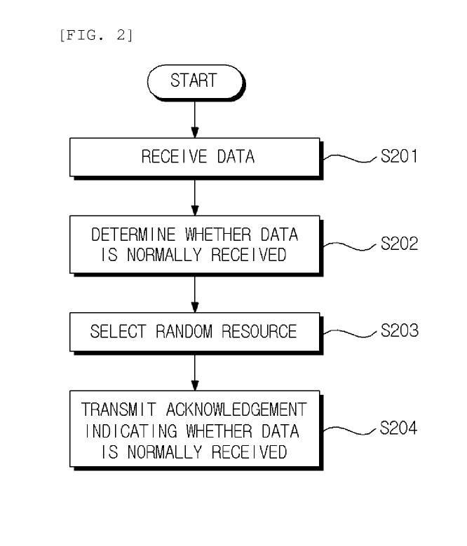

FIG. 2 is a flowchart for describing an error management method in multicast or broadcast transmission by the receiver 121 of FIG. 1 disclosed in the present invention.

Referring to FIG. 2, the error management method in the multicast or broadcast transmission includes receiving data multicasted or broadcasted to the plurality of receivers 121, 122, 123, and 124 (S201), determining whether the data is normally received (S202), selecting a random resource from wireless resources through which an acknowledgement indicating whether the data is normally received is to be transmitted, (S203), and transmitting the acknowledgement indicating whether the data is normally received through the selected random resource (S204). As described above, since the receiver 121 randomly selects the wireless resource through which the acknowledgement indicating whether the data is normally received is to be transmitted, a protocol structure is simple to be easily implemented compared to a method of preliminarily allocating a specific wireless resource.

Here, the wireless resource may be a plurality of resources allocated so as for the plurality of receivers 121, 122, 123, and 124 to commonly transmit the acknowledgement indicating whether the data is normally received. The acknowledgement indicating whether the data is normally received in the plurality of receivers 121, 122, 123, and 124 utilizes a specific wireless resource in a communication system, and the respective receivers 121, 122, 123, and 124 randomly select a resource block for the specific wireless resource, and transmits the acknowledgement indicating whether the data is normally received through the selected resource block.

The determining S202 may include determining whether to transmit the acknowledgement indicating whether the data is normally received by comparing a predetermined transmission threshold and a randomly selected selection value. Accordingly, the receiver 121 does not transmit the acknowledgement indicating whether the data is normally received for every case, but determines whether to transmit the acknowledgement according to a predetermined probabilistic statistic, thereby effectively managing an error for the data transmission without requiring large overhead.

In the meantime, the determining S202 may include determining whether to transmit the acknowledgement indicating whether the data is normally received according to a type of data. In this case, the acknowledgement indicating whether the data is normally received may not be transmitted for specific data. For example, the acknowledgement indicating whether the data is normally received may not be transmitted for non-interested data.

In the transmitting of the acknowledgement indicating whether the data is normally received (S204), the acknowledgement indicating whether the data is normally received transmitted by the plurality of receivers 121, 122, 123, and 124 may have the same signal type. Accordingly, even though a collision occurs in the wireless sources randomly selected by the plurality of receivers, the transmitter 110 may normally receive the acknowledgement. When the plurality of receivers transmit the same type of acknowledgement signals through the same wireless resource, the transmitter 110 seems to consider that the acknowledgement signal receives a multi-path effect, thereby achieving normal reception of the acknowledgement signal.

The acknowledgement indicating whether the data is normally received may include weight information on the data. The weight may be used as a basis for determining whether to retransmit the data or changing the modulation scheme or the coding scheme for data transmission by the transmitter 110. For example, the receiver 121 differently sets the weight according to the type of data, such as a QoS level for the received data or a degree by which the receiver 121 desires to receive data, and transmits the differently set weight to the transmitter 110, so that the transmitter 110 may determine whether to retransmit the data or change the modulation scheme or the coding scheme for the data transmission by using the weight.

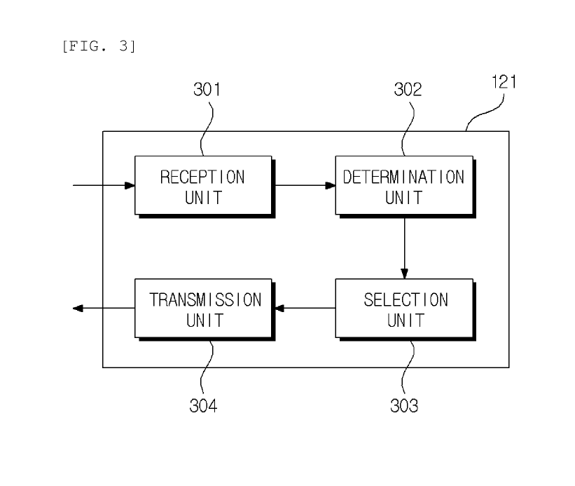

FIG. 3 is a diagram for describing the receiver 121 in multicast or broadcast transmission illustrated in FIG. 1 disclosed in the present invention.

Referring to FIG. 3, the receiver 121 in the multicast or broadcast transmission includes a reception unit 301 for receiving data multicasted or broadcasted to the plurality of receivers 121, 122, 123, and 124, a determination unit 301 for determining whether the data is normally received, a selection unit 303 for selecting a random resource from wireless resources through which an acknowledgement indicating whether the data is normally received is to be transmitted, and a transmission unit 304 for transmitting the acknowledgement indicating whether the data is normally received through the selected random resource. Here, the determination unit 302 and the selection unit 303 may be processed in the same function block according to implementation. Here, the wireless resource may be a plurality of resources allocated so as for the plurality of receivers 121, 122, 123, and 124 to commonly transmit the acknowledgement indicating whether the data is normally received.

The determination unit 302 may determine whether to transmit the acknowledgement indicating whether the data is normally received by comparing a predetermined transmission threshold value and a randomly selected selection value, or the determination unit 302 may determine whether to transmit the acknowledgement indicating whether the data is normally received according to the type of data. In the meantime, the acknowledgement indicating whether the data is normally received may include weight information on the data.

A part overlapping the description of the error management method in the multicast or broadcast transmission of FIG. 2 among other detailed descriptions will be omitted.

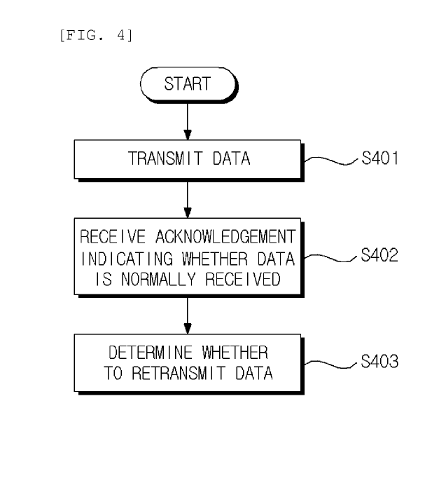

FIG. 4 is a flowchart for describing an error management method in multicast or broadcast transmission by the transmitter 110 of FIG. 1 disclosed in the present invention.

Referring to FIG. 4, the error management method in the multicast or broadcast transmission includes transmitting multicasted or broadcasted data to the plurality of receivers 121, 122, 123, and 124 (S401), receiving an acknowledgement indicating whether the data is normally received through a random resource selected from wireless resources, through which the acknowledgement indicating whether the data is normally received is to be transmitted, from the plurality of receivers 121, 122, 123, and 124 (S402), and determining whether to retransmit the data based on a comparison result obtained by comparing the number of received acknowledgements indicating whether the data is normally received and a predetermined acknowledgement threshold value (S403). Here, the wireless resource may be a plurality of resources allocated so as for the plurality of receivers 121, 122, 123, and 124 to commonly transmit the acknowledgement indicating whether the data is normally received.

Here, the determining S403 may include changing the modulation scheme or the coding scheme for data transmission based on the comparison result. Accordingly, in the determining S403, whether to retransmit the data is determined, and the modulation scheme or the coding scheme for the retransmitted data or data to be subsequently transmitted may be changed based on the comparison result.

Whether to transmit the acknowledgement indicating whether the data is normally received may be determined by comparing a predetermined transmission threshold value and the randomly selected selection value. Whether to transmit the acknowledgement indicating whether the data is normally received may be determined by the receiver 121. Depending on implementation, the predetermined transmission threshold is determined by the transmitter 110 to be reported to the receiver 121, and the selection value is randomly selected by the receiver 121, so that the receiver 121 may compare the predetermined transmission threshold and the randomly selected selection value. In the meantime, the acknowledgement indicating whether the data is normally received may include weight information on the data. The weight may be determined by the receiver 121. Otherwise, depending on implementation, a method of determining a category for the weight by the transmitter 110 and notifying the receiver 121 of the determined category may be used. The transmitter 110 receiving the weight information may determine whether to retransmit the data or change the modulation scheme of the coding scheme for data transmission based on the received weight information.

A part overlapping the descriptions of FIGS. 2 and 3 among other detailed descriptions will be omitted.

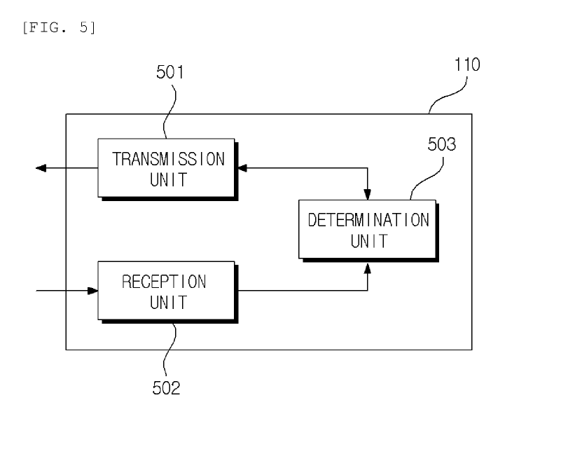

FIG. 5 is a diagram for describing the transmitter 110 in multicast or broadcast transmission illustrated in FIG. 1 disclosed in the present invention.

Referring to FIG. 5, the transmitter 110 in the multicast or broadcast transmission includes a transmission unit 501 for transmitting multicasted or broadcasted data to the plurality of receivers 121, 122, 123, and 124, a reception unit 502 for receiving an acknowledgement indicating whether the data is normally received through a random resource selected from wireless resources, through which the acknowledgement indicating whether the data is normally received is to be transmitted, from the plurality of receivers 121, 122, 123, and 124, and a determination unit 503 for determining whether to retransmit the data based on a comparison result obtained by comparing the number of received acknowledgements indicating whether the data is normally received and a predetermined acknowledgement threshold value. Here, the wireless resource may be a plurality of resources allocated so as for the plurality of receivers 121, 122, 123, and 124 to commonly transmit the acknowledgement indicating whether the data is normally received.

The determination unit 503 may change the modulation scheme or the coding scheme for data transmission based on the comparison result.

Whether to transmit the acknowledgement indicating whether the data is normally received may be determined by comparing a predetermined transmission threshold value and the randomly selected selection value. In the meantime, the acknowledgement indicating whether the data is normally received may include weight information on the data.

A part overlapping the descriptions of FIGS. 2 to 4 among other detailed descriptions will be omitted.

Hereinafter, a specific embodiment of the error management method in the multicast or broadcast transmission disclosed in the present invention and the apparatus thereof will be described in more detail with reference to the drawings.

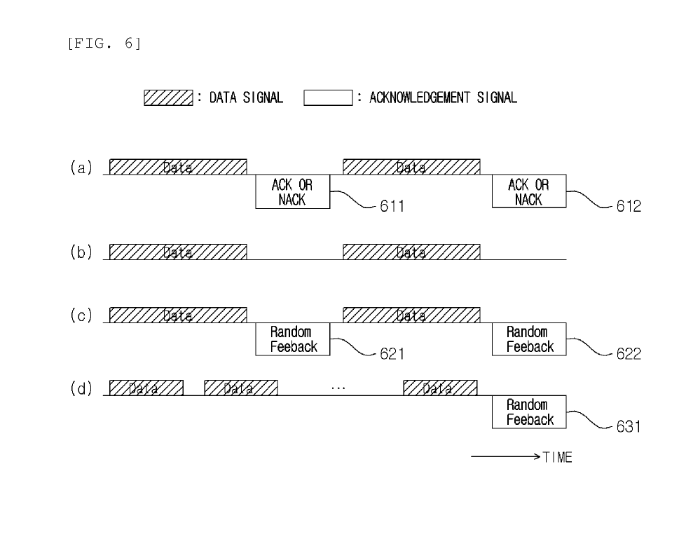

FIG. 6 is a diagram for comparing and describing the error management method in multicast or broadcast transmission disclosed in the present invention and that of the related art.

(a) of FIG. 6 illustrates an error management mode by an immediate acknowledgement method in a general unicast. The receiver 121 receives the data transmitted by the transmitter 110 and then the receiver 121 transmits whether to receive the data to the transmitter 110 through ACK or NACK 611 or 612. In order to reduce overhead due to immediate acknowledgement, a block acknowledgement mode of receiving several data and then transmitting acknowledgements at once may be used.

(b) of FIG. 6 illustrates a general multicast or broadcast transmission mode. Only the transmitter 110 in the general multicast or broadcast transmits data to be transmitted, but the receiver 121 does not transmit a separate acknowledgement. Accordingly, when an error is generated in the data, it is difficult to correct the error. In order to supplement the difficulty, each transmitter 110 transmits the multicasted or broadcasted data through a common channel, in such a way that the acknowledgement transmitted from the receiver 121 to the transmitter 110 may be transmitted by using a separate wireless resource allocated to each receiver 121. However, this deteriorates wireless resource utilization efficiency.

(c) of FIG. 6 illustrates an exemplary embodiment of the error management method in the multicast or broadcast transmission disclosed in the present invention. The transmitter 110 transmits data to the receiver 121 through common wireless resources. The receiver 121 transmits a fact indicating whether the data is normally received through random feedback 621 and 622. Here, the random feedback means an acknowledgement mode of making an acknowledgement by selecting acknowledgement wireless resources by a random mode by the respective receivers 121. That is, the wireless resources through which the respective receivers 121 transmit the acknowledgements are not determined like the unicast transmission mode, but the wireless resources through which all receivers 121 may commonly transmit the acknowledgements are determined, and the receivers 121 transmit the acknowledgement indicating whether the data is normally received by selecting the wireless resource by the random mode.

(d) of FIG. 6 illustrates an exemplary embodiment in which the receivers 121 receive one or more multicasted or broadcasted packet or frame data and then transmit the acknowledgements for the received packets or frame data at one time similar to the block acknowledgement of the unicast mode described in FIG. 6C (631).

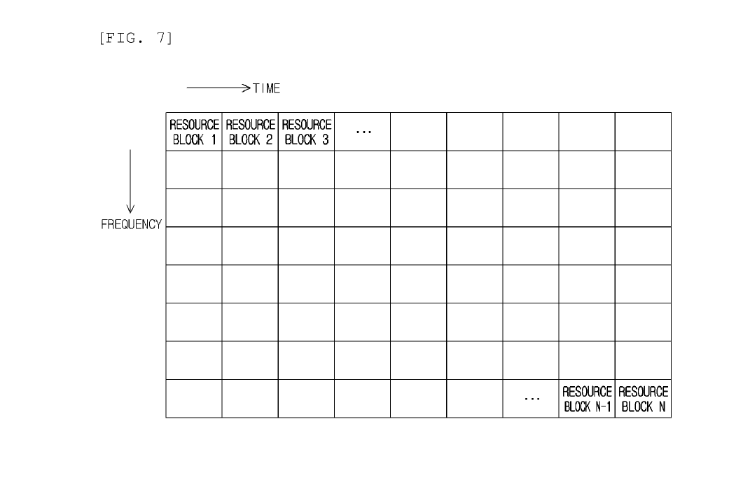

FIG. 7 is a diagram for describing an exemplary embodiment in which the error management method in the multicast or broadcast transmission disclosed in the present invention is applied to an orthogonal frequency-division multiple access (OFDMA) transmission mode.

Referring to FIG. 7, a random feedback section in a system using the OFDAM transmission mode is illustrated. The random feedback section in the OFDMA transmission mode is divided into resource blocks. Each quadrangle in FIG. 7 represents one resource block. The receiver 121 which fails to normally receive the data transmitted by the transmitter 110 transmits ACK or NACK by randomly selecting one among the resource blocks.

In a case of using time-division multiple access (TDMA), when the data receiver 121 transmits the acknowledgement by dividing a time section into predetermined n sections, the data receiver 121 may transmit the acknowledgement to a random time section, and in a case of using frequency-division multiple access (FDMA), when the data receiver 121 transmits the acknowledgement by dividing a frequency section into predetermined n sections, the data receiver 121 may transmit the acknowledgement to a random frequency section. Similarly, code-division multiple access (CDMA) may be used in a case where the receiver 121 transmits NACK or ACK by randomly selecting one code among n codes.

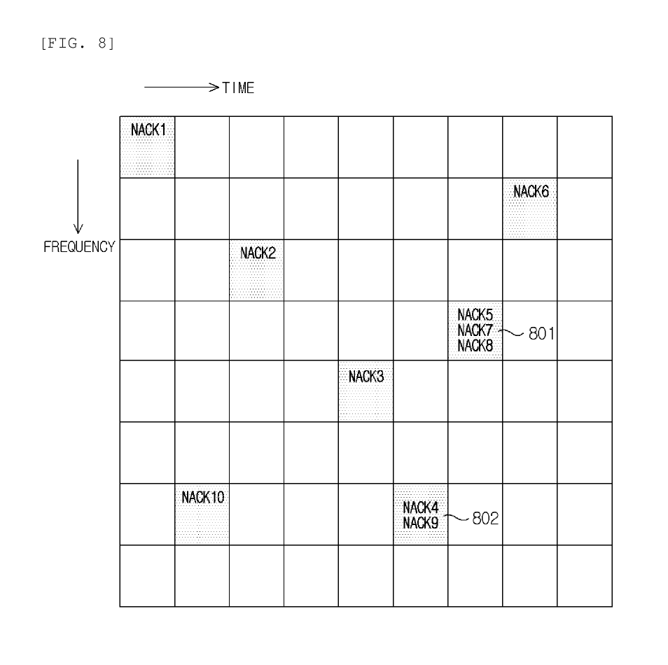

FIG. 8 is a diagram for describing an exemplary embodiment in which a NACK is used as the acknowledgement indicating whether data is normally received in the error management method in multicast or broadcast transmission disclosed in the present invention.

Referring to FIG. 8, when the receiver 121 receiving the data from the transmitter 110 normally receives the data, the receiver 121 performs no operation, but when the receiver 121 fails to normally receive the data, the receiver 121 transmits an NACK signal to the transmitter 110. In this case, each receiver 121 transmits the acknowledgement by using a random resource block when transmitting the acknowledgement.

Accordingly, depending on a case, the acknowledgements of the plurality of receivers 121 may overlap one resource block to be transmitted. This case may be solved by allocating different codes to the respective receivers 121. In the meantime, since the same resource block is used, collision of the same signals may occur, but even in this case, the probabilistic statistics for the acknowledgement of the plurality of receivers 121 may be obtained. The transmitter 110 receiving the acknowledgement may recognize current probabilistic reception states of the receivers 121 from the acknowledgement. For example, the transmitter 110 sets a predetermined threshold value by using probabilistic acknowledgement information, and only when the NACK signal is generated in the predetermined number of resource blocks or more, the transmitter 110 may correct the error by the method of retransmitting the data.

When the number of receivers 121 receiving the multicasted or broadcasted data is considerably larger than that of the resource blocks, it is possible to prevent the NACK from being continuously generated in all of the resource sections by controlling an acknowledgement transmission probability. As described above, when the acknowledgement transmission probability is controlled according to the number of receivers 21, it is possible to smoothly control the recognition of the probabilistic reception states. For example, even though the receivers 121 do not normally receive the data, the receivers 121 do not unconditionally transmit the NACK, but determine whether to transmit the NACK according to a specific probability.

The different numerals beside NACK in resource blocks 801 and 802 of FIG. 8 represent the acknowledgements transmitted by the different receivers 121. It can be seen that NACK4 and NACK9 are present in one resource block 802 of FIG. 8. Even though the acknowledgements transmitted from the different receivers 121 are present in the same resource block, it is not difficult to determine whether the acknowledgement signal is present in the corresponding resource block. For example, when all of the respective devices generate the same signals as the NACK signal, it is possible to easily detect whether the NACK signal is present even though the same resource block is used.

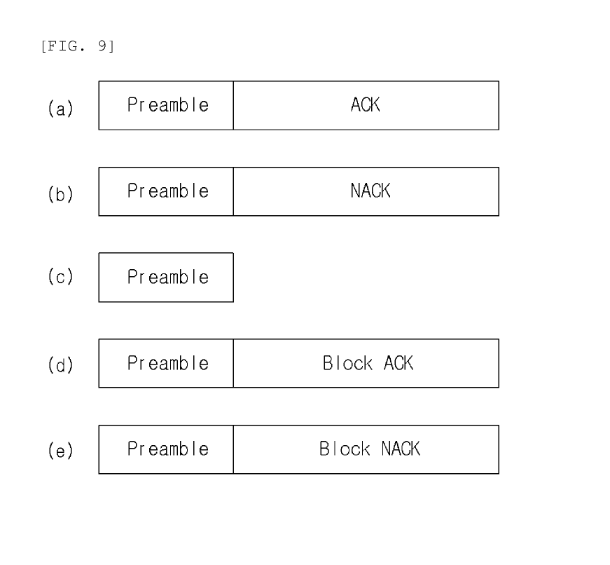

FIG. 9 is a diagram for describing an exemplary embodiment of signals for an acknowledgement indicating whether the data is normally received in the receiver 121 in the error management method in multicast or broadcast transmission disclosed in the present invention. In general, a PHY frame and an MAC frame are separated according to an OSI 7 layer division method. However, in FIG. 9, a preamble indicating a physical signal for synchronization, and the like and logical information are separately illustrated, not the OSI 7 layer method.

(a) and (b) of FIG. 9 illustrate generally used ACK and NACK frames. In this case, a signal includes the ACK or NACK frame together with the preamble.

(c) of FIG. 9 illustrates a case where only the preamble is used when the acknowledgement indicating whether the data is normally received is transmitted by the receiver 121. When the transmitter 110 transmits the data, the transmitter 110 may set a type and a method of the acknowledgement and then transmit the data. In a case where the transmitter 110 requests the ACK, a method, in which when the respective receivers 121 normally receive the data, the respective transmitters 121 transmit only the preamble, and the transmitter 110 interprets the preambles as the ACK, may be used. Even in a case where the transmitter 110 requests the NACK, the similar operation is performed. As described above, when only the preamble is used as the acknowledgement indicating whether the data is received, it is possible to decrease overhead due to the acknowledgement, and it is possible to easily detect generation of collision even when the collision occurs between the acknowledgements.

(d) and (e) of FIG. 9 illustrate acknowledgements Block ACK or Block NACK in a mode of transmitting data reception results over several times with one-time acknowledgement.

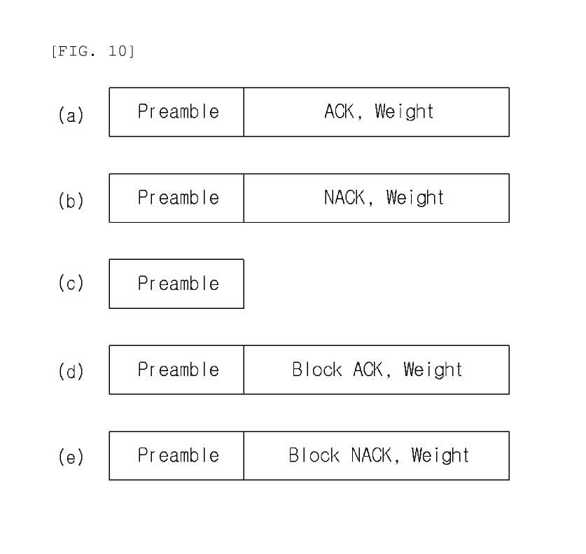

FIG. 10 is a diagram for describing an exemplary embodiment in which weight information is included in the signal for the acknowledgement indicating whether data is normally received in the error management method in multicast or broadcast transmission disclosed in the present invention.

The respective receivers 121 may display degrees by which the respective receivers 121 desire to receive currently received data by a weight. For example, a certain receiver 121 may multicast or broadcast the received data to another device again, and in this case, the receiver 121 may express its weight. The transmitter 110 may determine whether to retransmit the data or change the modulation or coding scheme by reflecting the weight.

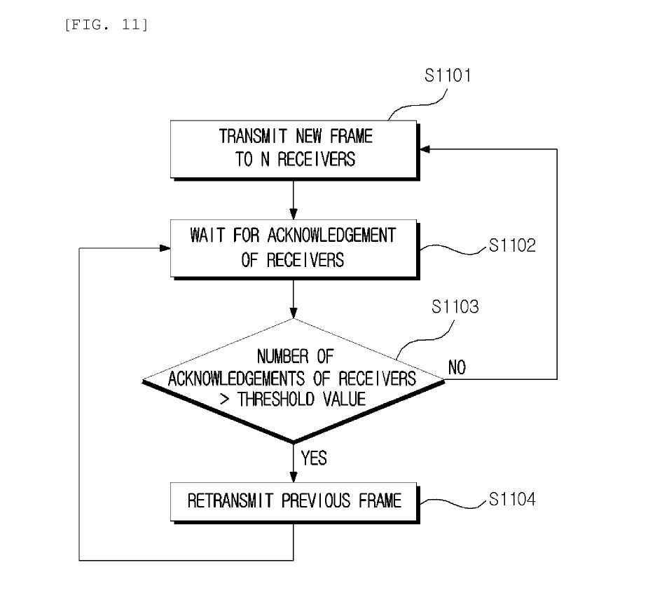

FIG. 11 is a diagram for describing an exemplary embodiment of an operation of the transmitter 110 in the multicast or broadcast transmission disclosed in the present invention. In the present exemplary embodiment, an immediate acknowledgement is used and NACK is used for the error management in the OFDMA.

Referring to FIG. 11, the transmitter 110 transmits a frame (S1101) and waits for an acknowledgement of the receiver 121 (S1102). In this case, the receiver 121 transmits the acknowledgement through a random feedback. When the number of NACKs received in the transmitter 110 is larger than that of a threshold value (S1103), the transmitter 110 determines that many receivers 121 do not receive the data and retransmits a previous frame (S1104). However, when the number of NACKs of the receivers 121 is smaller than that of the threshold value, the transmitter 110 determines that many receivers 121 receive the acknowledgements normally and continuously transmits a new frame (S1101). In a case where the ACK is used, when the number of acknowledgements of the receiver 121 is larger than the threshold value, the transmitter 110 transmits a new frame, but when the number of acknowledgements of the receiver 121 is smaller than the threshold value, the transmitter 110 retransmits a previous frame (S1104).

When a data amount is small and the data is important, the transmitter 110 may essentially transmit the data by reducing the threshold value, and when a data amount is large and the data is not important, the transmitter 110 may improve transmission efficiency by improving the threshold value. Accordingly, the retransmission may be controlled through the threshold value, and transmission stability and efficiency may be changed by changing a modulation coding scheme (MCS) or the modulation scheme of a data frame to be subsequently transmitted.

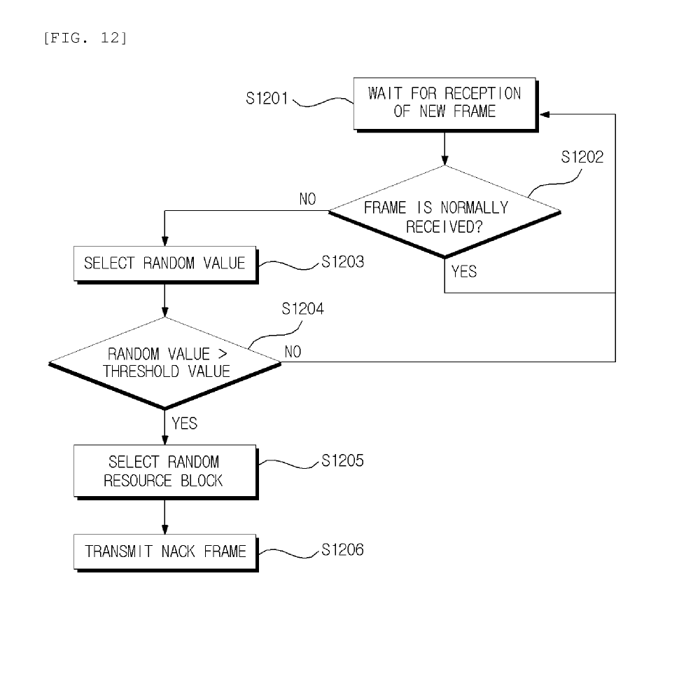

FIG. 12 illustrates a diagram for describing an exemplary embodiment of an operation of the receiver 121 in the multicast or broadcast transmission disclosed in the present invention. FIG. 12 is also an exemplary embodiment in which an immediate acknowledgement is used and a NACK is used in the OFDMA identically to that of FIG. 11.

Referring to FIG. 12, the receiver 121 receives a new frame (S1201), and when the receiver 121 does not normally receive the frame (S1202), the receiver 121 selects a random value (S1203). When the random value is higher than a threshold value (S1204), the receiver 121 transmits the NACK (S1206). In this case, the receiver 121 transmits the NACK by selecting a random resource block among random feedback resource blocks (S1205).

Here, the transmitter 110 receiving the acknowledgements may recognize a more accurate statistical reception state by adjusting the threshold value according to the number of receivers 121. For example, when it is assumed that the random value is selected between 0 and 1, and the threshold value is selected as −1, the receiver 121 unconditionally transmits the acknowledgement in the conditions where the receiver 121 needs to transmit the acknowledgement. On the contrary, when a value close to 1 is selected as the threshold value, a probability that the receiver 121 does not transmit the acknowledgement is increased, so that the receiver 121 may be similarly operated to the general multicast or broadcast transmission mode. The acknowledgement transmission probability may be controlled by the aforementioned method.

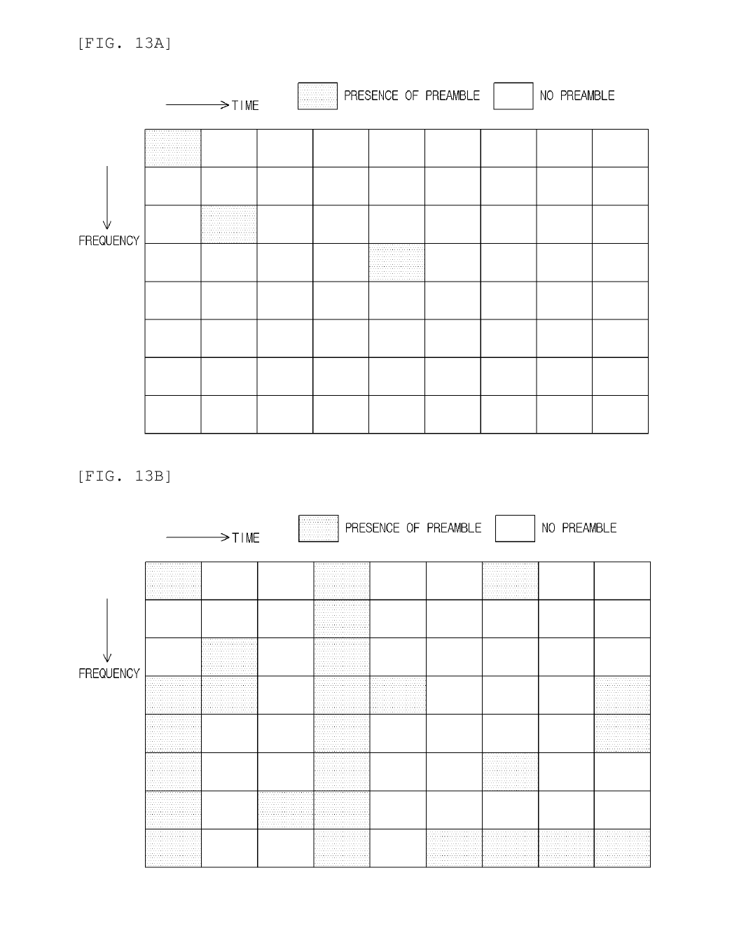

FIG. 13 is a diagram for describing an exemplary embodiment of an acknowledgement which the data transmitter receives through random feedback when OFDMA is used in the multicast or broadcast transmission disclosed in the present invention. FIG. 13 represents a case where the NACK is substituted with the preamble to be transmitted, and illustrates an exemplary embodiment of a case where a threshold value which the transmitter 110 needs to retransmit is determined as five resource blocks.

In FIG. 13A, since the number (three) of NACKs is smaller than the threshold value, the retransmission is not performed, and in FIG. 13B, since the number of NACKs is larger than the threshold value, the retransmission is performed. In this case, each acknowledgement is configured of the preamble, even though a collision is generated because synchronization of the respective preambles is not accurate or several acknowledgements are transmitted to one resource block, it is possible to easily detect whether at least one preamble is present. The transmitter 110 may determine the threshold value by considering a collision probability, and the like when determining the threshold value.

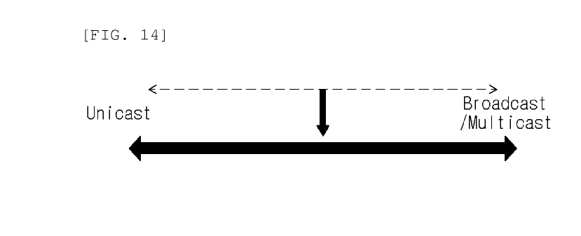

FIG. 14 is a diagram for schematically describing a concept of the error management method in the multicast or broadcast transmission disclosed in the present invention.

Referring to FIG. 14, the error management method in the multicast or broadcast transmission disclosed in the present invention is reconciled with the error management methods in unicast, and multicast or broadcast. In the error management, such as the retransmission, in the unicast, an error may be corrected, but wireless resources are inefficiently used, and in the multicast or broadcast, an error may not be corrected, but wireless resources are efficiently used, so that the error management method in the multicast or broadcast transmission disclosed in the present invention has the concept in which the error management method in the unicast is traded-off against the error management method in the multicast or the broadcast in an aspect of an error correction and efficient utilization of the wireless resources. Accordingly, according to the error management method in the multicast or broadcast transmission disclosed in the present invention, an error may be effectively managed without requiring large overhead, and a data transmission success probability may be adjusted through the acknowledgement transmission probability and the retransmission threshold value.

The method may be especially utilized for digital newspapers, books, and advertisement. For example, when a service provider provides a newspaper article service, the service provider may obtain statistical information on the number of receivers 121 currently receiving the data and the number of successful transmission through the reception acknowledgement through random feedback. Further, a user receiving the service may set the desired type of articles in advance, and transmit an ACK or NACK only for the desired type of articles, thereby improving a probability that the user receives the desired article.

Finally, the error management method in the multicast or broadcast transmission disclosed in the present invention is a method of transmitting the acknowledgement of the receiver 121 indicating whether the data is normally received in the multicast or broadcast transmission mode through a random feedback section, and the random feedback section include a plurality (two or more) of wireless resources, and the acknowledgement indicating whether the data is received is transmitted by randomly selecting the wireless resource among the plurality (two or more) of wireless resources.

A size of the wireless resource allocated to the random feedback may be dynamically adjusted according to the number of receivers 121 or a characteristic of transmission data. In the meantime, it is possible to obtain statistical reception state information by assigning a weight for the acknowledgement according to the characteristic of the receiver 121 and reflecting the weight. The weight for the acknowledgement may be displayed through different code divided preambles. Further, the receiver 121 may set an interested type of data in advance, and may not transmit the ACK or NACK for non-interested data.

The signal for the acknowledgement may be configured of only the preamble, so that the receiver 121 may express the ACK or NACK only with the preamble, and a plurality of code divided preambles may be used as the preamble.

The transmitter 110 may obtain the statistical reception state information through the random feedback section, and determine whether to retransmit the data according to the obtained statistical reception state or change the modulation scheme or the coding scheme.

In the meantime, in a condition where the receiver 121 needs to transmit the ACK or NACK, the receiver 121 does not unconditionally transmit the ACK or NACK, and may determine whether to transmit the ACK or NACK according to the acknowledgement transmission probability set by the transmitter 110.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method of managing an error in multicast or broadcast transmission, comprising:
receiving data multicasted or broadcasted to a plurality of receivers;
determining whether the data is normally received;
selecting a random resource among wireless resources through which an acknowledgement indicating whether the data is normally received is to be transmitted; and
transmitting the acknowledgement indicating whether the data is normally received through the selected random resource.

2. The method of claim 1, wherein the wireless resources are a plurality of resources allocated so that the plurality of receivers commonly transmits the acknowledgement indicating whether the data is normally received.

3. The method of claim 2, wherein the determining includes determining whether to transmit the acknowledgement indicating whether the data is normally received by comparing a predetermined transmission threshold value and a randomly selected selection value.

4. The method of claim 2, wherein the determining includes determining whether to transmit the acknowledgement indicating whether the data is normally received according to a type of data.

5. The method of claim 2, wherein the acknowledgement indicating whether the data is normally received includes weight information on the data.

6. A receiver in multicast or broadcast transmission, comprising:
a reception unit configured to receive data multicasted or broadcasted to a plurality of receivers;
a determination unit configured to determine whether the data is normally received;
a selection unit configured to select a random resource among wireless resources through which an acknowledgement indicating whether the data is normally received is to be transmitted; and
a transmission unit configured to transmit the acknowledgement indicating whether the data is normally received through the selected random resource.

7. The receiver of claim 6, wherein the wireless resources are a plurality of resources allocated so that the plurality of receivers commonly transmits the acknowledgement indicating whether the data is normally received.

8. The receiver of claim 7, wherein the determination unit determines whether to transmit the acknowledgement indicating whether the data is normally received by comparing a predetermined transmission threshold value and a randomly selected selection value.

9. The receiver of claim 7, wherein the determination unit determines whether to transmit the acknowledgement indicating whether the data is normally received according to a type of data.

10. The receiver of claim 7, wherein the acknowledgement indicating whether the data is normally received includes weight information on the data.

11. A method of managing an error in multicast or broadcast transmission, comprising:
transmitting multicasted or broadcasted data to a plurality of receivers;
receiving an acknowledgement indicating whether the data is normally received through a random resource selected from wireless resources, through which the acknowledgement indicating whether the data is normally received is to be transmitted, from the plurality of receivers; and
determining whether to retransmit the data based on a comparison result obtained by comparing the number of received acknowledgements indicating whether the data is normally received and a predetermined acknowledgement threshold value.

12. The method of claim 11, wherein the wireless resources are a plurality of resources allocated so that the plurality of receivers commonly transmits the acknowledgement indicating whether the data is normally received.

13. The method of claim 12, wherein the determining includes changing a modulation scheme or a coding scheme of data transmission based on the comparison result.

14. The method of claim 12, wherein whether to transmit the acknowledgement indicating whether the data is normally received is determined by comparing a predetermined transmission threshold value and a randomly selected selection value.

15. The method of claim 12, wherein the acknowledgement indicating whether the data is normally received includes weight information on the data.

16. A transmitter in multicast or broadcast transmission, comprising:
a transmission unit configured to transmit multicasted or broadcasted data to a plurality of receivers;
a reception unit configured to receive an acknowledgement indicating whether the data is normally received through a random resource selected from wireless resources, through which the acknowledgement indicating whether the data is normally received is to be transmitted, from the plurality of receivers; and
a determination unit configured to determine whether to retransmit the data based on a comparison result obtained by comparing the number of received acknowledgements indicating whether the data is normally received and a predetermined acknowledgement threshold value.

17. The transmitter of claim 16, wherein the wireless resources are a plurality of resources allocated so that the plurality of receivers commonly transmits the acknowledgement indicating whether the data is normally received.

18. The transmitter of claim 17, wherein the determination unit changes a modulation scheme or a coding scheme of data transmission based on the comparison result.

19. The transmitter of claim 17, wherein whether to transmit the acknowledgement indicating whether the data is normally received is determined by comparing a predetermined transmission threshold value and a randomly selected selection value.

20. The transmitter of claim 17, wherein the acknowledgement indicating whether the data is normally received includes weight information on the data.
